(19) United States
(12) Patent Application Publication
(10) Pub. No.: US 2014/0006644 A1
(43) Pub. Date: Jan. 2, 2014

(54) Address Remapping Using Interconnect Routing Identification Bits

(71) Applicants: Sakthivel Komarasamy Pullagoundapatti, Bangalore (IN); Krishna Venkanna Bhandi, Bangalore (IN); Chithambaranathan G, Bangalore (IN); Claus Pribbernow, Munich (DE); Shrinivas Sureban, Bangalore (IN)

(72) Inventors: Sakthivel Komarasamy Pullagoundapatti, Bangalore (IN); Krishna Venkanna Bhandi, Bangalore (IN); Chithambaranathan G, Bangalore (IN); Claus Pribbernow, Munich (DE); Shrinivas Sureban, Bangalore (IN)

(73) Assignee: LSI CORPORATION, Milpitas, CA (US)

(21) Appl. No.: 13/536,647

(22) Filed: Jun. 28, 2012

(51) Int. Cl. G06F 3/00

(52) U.S. Cl. 710/4

(57) ABSTRACT

A method for mapping addresses between one or more master devices and at least one common slave device in a multiprocessor system is provided, the system including a bus interconnect for interfacing between the master devices and the common slave device. The method includes steps of: receiving a first address corresponding to a bus transaction between a given one of the one or more master devices and the common slave device; decoding a unique identifier associated with the given one of the one or more master devices; and generating a second address as a function of the first address and the unique identifier for remapping access to the common slave device by the given one of the one or more master devices.

### BACKGROUND

In a multiprocessor system which requires access to a common memory region, for example during system boot-up, external address remapping logic is often utilized. Typically, the address remapping logic is added to a connection path between each processor and a bus interconnect (i.e., before the bus interconnect). The system also requires additional address decoding in the bus interconnect to route the remapped addresses. An address space restriction is placed on the system during system design, and, undesirably, it is generally not possible to allocate remapped address spaces to other slave devices passing through the same bus interconnect.

### SUMMARY

In accordance with an embodiment of the invention, a method for mapping addresses between one or more master devices and at least one common slave device in a multiprocessor system is provided, the system including a bus interconnect for interfacing between the master devices and the common slave device. The method includes steps of: receiving a first address corresponding to a bus transaction between a given one of the one or more master devices and the common slave device; decoding a unique identifier associated with the given one of the one or more master devices; and generating a second address as a function of the first address and the unique identifier for remapping access to the common slave device by the given one of the one or more master devices.

Apparatus and an electronic system for facilitating address mapping between one or more master devices and at least one common slave device are also provided.

Embodiments of the invention will become apparent from the following detailed description thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram depicting at least a portion of an exemplary multiprocessor system, including address remapping logic, which can be modified to implement techniques according to embodiments of the invention;

FIG. 2 is a block diagram depicting at least a portion of an exemplary multiprocessor system which includes address remapping based on interconnect routing identification bits, according to an embodiment of the invention;

FIG. 3 is a flow diagram depicting at least a portion of an exemplary method for remapping addresses in a multiprocessor system, according to an embodiment of the invention; and

FIG. 4 is a block diagram depicting at least a portion of an exemplary electronic system adapted to perform methodologies according to embodiments of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Embodiments of the invention will be described herein in the context of illustrative methods and/or apparatus for remapping addresses to a common memory in a multiprocessor system in a manner which advantageously simplifies address decoding, reduces the number of remapping logic units required for generating the remapped addresses, reduces integrated circuit area, and reduces overall power consumption in the system, among other benefits. It should be understood, however, that embodiments of the invention are not limited to these or any other particular methods and/or apparatus. While embodiments of the invention may be described herein with reference to specific protocols or address ranges or mappings, it is to be understood that the embodiments of the invention are not limited to the protocols, address ranges or mappings shown and described herein, and that aspects of embodiments of the invention may be performed using other protocols or address ranges or mappings, as will become apparent to those skilled in the art. Moreover, it will become apparent to those skilled in the art given the teachings herein that numerous modifications can be made to the embodiments shown that are within the scope of the claimed invention. That is, no limitations with respect to the embodiments shown and described herein are intended or should be inferred.

As a preliminary matter, for the purposes of clarifying and describing embodiments of the invention, the following table provides a summary of certain acronyms and their corresponding definitions, as the terms are used herein:

Table of Acronym Definitions

| Acronym | Definition |
|---|---|
| MB | Megabyte |
| ID | Identification or identifier (depending on context) |
| AMBA | Advanced Microcontroller Bus Architecture |
| AXI | Advanced eXtensible Interface |
| ROM | Read-only memory |
| RAM | Random access memory |
| SRAM | Static random access memory |
| SDRAM | Synchronous dynamic random access memory |
| MRAM | Magnetoresistive random access memory |
| PCRAM | Phase-change random access memory |
| AHB | Advanced High-performance Bus |
| ASB | Advanced System Bus |
| ATB | Advanced Trace Bus |
| CPU | Central processing unit |

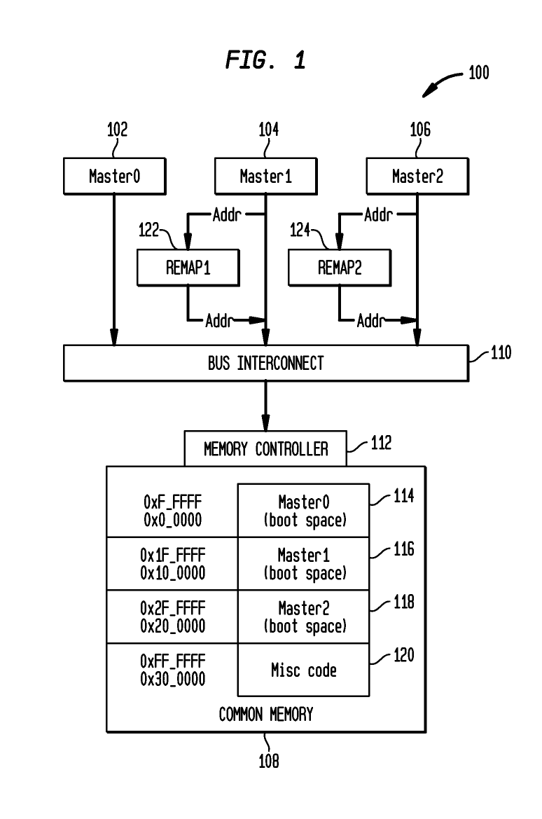

FIG. 1 is a block diagram depicting at least a portion of an exemplary multiprocessor system 100 including address remapping logic, which can be modified to implement techniques in accordance with embodiments of the invention. The system 100 includes three master devices (or masters), Master0 102, Master2 104 and Master2 106, which access a common memory 108 or other slave device through a bus interconnect 110, or alternative interface circuitry, and corresponding address decoding logic, implemented in this embodiment as a memory controller 112. A bus interconnect, which falls under the broader umbrella of an “on-chip interconnect,” is used by one or more master devices to access a common slave device in a multiprocessor system. The term “device” (e.g., “master device” or “slave device”) as used herein is intended to broadly refer to hardware (e.g., processor, controller, etc.), software (e.g., program instructions), or a functional module or other entity which incorporates hardware and/or software aspects.

The common memory 108 is divided into a plurality of addressable regions, some of which are dedicated to a corresponding master device and some of which are accessible to multiple master devices. For example, a first region 114 having an address range 0x0_{—}0000 to 0xF_FFFF is allocated to Master0 102 boot space, a second region 116 having an address range 0x10_{—}0000 to 0x1F_FFFF is allocated to Master1 104 boot space, a third region 118 having an address range 0x20_{—}0000 to 0x2F_FFFF is allocated to Master2 106 boot space, and a fourth region 120 having an address range 0x30_{—}0000 to 0x3F_FFFF is allocated to miscellaneous code (e.g., common test code) in the common memory 108 which can be accessed by all of the master devices 102, 104 and 106.

After a reset has occurred, the processor address is typically fixed at 0x0, and all processors boot from the address 0x0, which resides within the boot space 114 allocated to Master0 102 in the common memory 108. Even if the processor address is set to a value other than 0x0, this address will most likely reside in a region of the common memory 108 which is not accessible to all of the master devices. Thus, address remapping is required outside of each processor (e.g., in master devices 102, 104, 106) to access non-overlapping address space, since a boot address location in the common memory 108 is typically unique for each processor.

In the system 100, since the Master1 104 and Master2 106 address allocations are different in the common memory 108 compared to Master0 102, external remapping logic is added to remap the respective Master1 and Master 2 addresses. More particularly, remapping logic (REMAP 1) 122 associated with the Master1 104 processor is operative to remap Master1 process addresses to the address range 0x10_{—}0000 to 0x1F_FFFF residing in region 116 of the common memory 108. Similarly, remapping logic (REMAP 2) 124 associated with the Master2 106 processor is operative to remap Master2 process addresses to the address range 0x20_{—}0000 to 0x2F_FFFF residing in region 118 of the common memory 108.

After address remap, the bus interconnect 110 sees three different addresses after reset, one from each of the master devices 102, 104 and 106, namely, addresses 0x0, 0x10_{—}0000 and 0x20_{—}0000, respectively, even though all processor addresses are fixed at 0x0 as a result of the reset. In this illustrative embodiment, a total of 3 megabytes (MB) of address space is allocated in the bus interconnect for boot space (e.g., 1 MB for each master), and this number grows based on the number of processors (e.g., master devices) connected with the bus interconnect 110. Moreover, an address space restriction is placed on the system during system design, and, undesirably, it is generally not possible to allocate remapped address spaces to other slave devices passing through the same bus interconnect. In this regard, the address range is unique for each common slave.

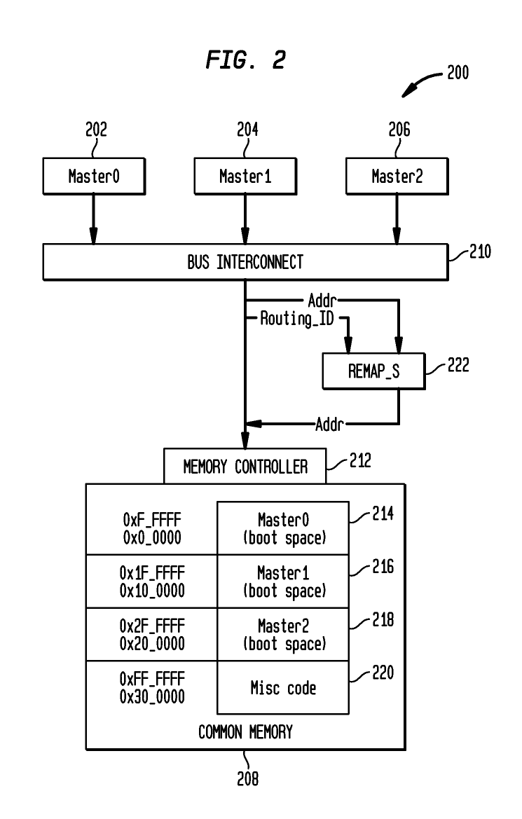

In accordance with embodiments of the invention, address remapping logic is placed after the bus interconnect; coupled in a data path between the bus interconnect and the common memory. The bus interconnect appends one or more extra bits (routing identification bits) to an actual identifier for identifying a unique processor/master in the multiprocessor system for a given transaction. More particularly, FIG. 2 is a block diagram depicting at least a portion of an exemplary multiprocessor system 200 which includes address remapping based on interconnect routing identification bits, according to an embodiment of the invention. The system 200 includes three master devices (or masters), Master0 202, Master2 204 and Master2 206, which access a common memory 208 through a bus interconnect 210 and corresponding address decoding logic, implemented in this embodiment as a memory controller 212. Although three master devices 202, 204 and 206 are shown in this illustrative embodiment, it is to be understood that embodiments of the invention are not limited to any specific number of master devices or processors.

As previously stated, a bus interconnect, which falls under the broader umbrella of an “on-chip interconnect” (which includes crossbar interconnects and the like), is used by one or more master devices to access a common slave device (e.g., common memory 208) in a multiprocessor system. Suitable implementations of a bus interconnect include, but are not limited to, ARM PrimeCell® High-Performance Matrix PL301 (a registered trademark of ARM Limited) and ARM AMBA (Advanced Microcontroller Bus Architecture) Interconnect NIC-301. Both the PL301 and NIC-301 support out-of-order transaction completion, wherein a second (subsequent) transaction completes before a first transaction.

Embodiments of the invention advantageously make use of interconnect routing identification (ID) bits, generated by the bus interconnect 210 for each transaction, or at least a subset of the transactions, through the bus interconnect, to decode which master device (e.g., masters 202, 204 or 206) is accessing a common slave device (e.g., common memory 208) for a given transaction through the interconnect. The number of bits used for a slave transaction identifier, in one embodiment, is a function of the master interface ID width and the total number of master interfaces. For example, in one embodiment, a slave transaction ID=(largest master interface ID width)+log₂(total number of master interfaces). In this embodiment, the routing ID bits are appended to an ID port, although any means of identifying the master device associated with a given bus transaction is contemplated by embodiments of the invention. For example, in the context of an Advanced eXtensible Interface (AXI) protocol, AWID[3:0] is a write address channel signal which is an identification tag for the write address group of signals, and ARID[3:0] is a read address channel signal which is an identification tag for the read address group of signals (see, e.g., “AMBA AXI Protocol Specification,” v1.0, ARM Limited, pp. 1-108, 2004, the disclosure of which is incorporated herein by reference in its entirety for all purposes).

The common memory 208 may comprise, for example, random access memory (RAM), such as, but not limited to, static RAM, dynamic RAM, synchronous dynamic RAM (SDRAM), magnetoresistive RAM (MRAM), phase-change RAM (PCRAM), flash memory, or combinations thereof. Some of the various types of memory may have certain benefits (e.g., speed, size, power consumption, storage duration, etc.) over other memory types depending upon the application in which the system 200 is employed. Nevertheless, it is to be stressed that the invention is not limited to any particular type (or types) of memory, and, for that reason, any other equally suitable memory type or combination of memory types may be utilized and the result will still come within the scope of embodiments of the invention.

The common memory 208 utilized by the master devices 202, 204 and 206, in this embodiment, is divided into a plurality of addressable regions, some of which are exclusively allocated to a corresponding master device and some of which are accessible to multiple master devices. For example, in the common memory 208, a first region 214 having an address range 0x0_{—}0000 to 0xF_FFFF is allocated to Master0 202 boot space, a second region 216 having an address range 0x10_{—}0000 to 0x1F_FFFF is allocated to Master1 204 boot space, a third region 218 having an address range 0x20_{—}0000 to 0x2F_FFFF is allocated to Master2 206 boot space, and a fourth region 220 having an address range 0x30_{—}0000 to 0x3F_FFFF is allocated to miscellaneous code (e.g., common test code) which is accessed by all of the master devices 202, 204 and 206. It is reiterated that the embodiments of the invention are not limited to the address ranges shown and described herein, and that aspects of the embodiments of the invention may be performed using other memory ranges, as will become apparent to those skilled in the art given the teachings herein.

The bus interconnect 210 may employ one or more of various known interface protocols, such as, for example, Advanced Microcontroller Bus Architecture (AMBA), which defines a plurality of bus/interface types; namely, Advanced eXtensible Interface (AXI), Advanced High-performance Bus (AHB), Advanced System Bus (ASB), Advanced Peripheral Bus (APB) and Advanced Trace Bus (ATB). Suitable devices for implementing the bus interconnect 210 include, but are not limited to, PrimeCell® High-Performance Matrix (PL301) and AMBA Network Interconnect (NIC-301), commercially available from ARM Limited. The bus interconnect 210, in accordance with embodiments of the invention, is adapted to append one or more identification routing bits to an actual ID to generate a final ID. The identification routing bits are indicative of the particular processor/master device associated with a given bus transaction accessing the common memory 208. These identification routing bits added by the bus interconnect to each transaction are decoded by the common slave device to determine which master device requested access. In this manner, routing overhead and congestion is beneficially reduced. Moreover, the need for remapping logic associated with each master device is eliminated, thereby further reducing overhead, integrated circuit area and power consumption.

The system 200 includes a remapping module or logic (REMAP_S) 222 in operative communication with an output of the bus interconnect; e.g., connected between the output of the bus interconnect 210 and the memory controller 212 of the common memory 208. The remapping module 222 is operative to receive the address and the appended identification bits and to generate a new address for use by the memory controller 212 for remapping the address to the appropriate region of the common memory 208 as a function of the identification bits. In this manner, the appended identification bits function as routing bits which beneficially eliminates the need for separate remapping logic (e.g., remapping logic 122 and 124 in FIG. 1) for each master device in the system. The remapping module 222 is replicated for write address and read address channels. Hence, this architecture advantageously reduces the complexity and hardware required for controlling access to a common memory utilized by multiple master devices in a multiprocessor system.

By way of example only and without limitation, consider the system 200 having three master devices 202, 204 and 206. With three master devices, only two identification bits are required to uniquely identify the source of a data transaction. In other embodiments wherein the number, m, of master devices employed is 2ⁿ⁻¹<m>2ⁿ, the number of identification bits needed to uniquely identify the source of the data transaction would be n, where m and n are integers. Consider the exemplary address assignments generated by the bus interconnect 210 using the identification bits as follows:

Master0 transactions: <actual identification bits>00

Master1 transactions: <actual identification bits>01

Master2 transactions: <actual identification bits>10

Here, the actual identification bits refer to the actual ID uniquely associated with a particular master device in the system. The identification bits added by the bus interconnect 210 to the master device actual ID are detected by the remapping module 222 and used to generate the address remap to the common memory 208 based on the exemplary rules shown in the table below.

| Identification | |
|---|---|
| Bits | Action |
| 00 | No address remapping is required |
| 01 | Address is remapped using a 1 MB offset (0x10_0000) |
| 10 | Address is remapped using a 2 MB offset (0x20_0000) |

For example, in the context of an AXI protocol, the actual identification bits are AWID, ARID and WID (which is a write ID tag). The bus interconnect 210 appends the routing bits to a AWID or ARID port associated with the master device. Using the illustrative rules shown in the table above, the remap logic 222 would decode the least significant two bits of the ID generated by the bus interconnect 210 as follows: when AWID[1:0]=00, no address remapping takes place; when AWID[1:0]=01, remap address to Master1 space; and when AWID[1:0]=10, no address remapping to Master2 space.

Additional offset schemes for generating the remapped addresses are contemplated according to other embodiments of the invention based on the number of master devices and the size of the memory regions allocated to each master device in the system, and may include other factors. While in this illustrative embodiment, each master device 202, 204 and 206 has been allocated the same size region (e.g., 1 MB) in the common memory 208, it is to be appreciated that the sizes of the respective regions 214, 216 and 218 allocated to the master devices need not be the same. Moreover, although each of the regions in the common memory 208 allocated to the master devices are contiguous in this embodiment, the allocated regions are not necessarily contiguous. Other actions to be performed as a function of the detected identification bits are similarly contemplated according to other embodiments of the invention.

The memory remapping architecture according to embodiments of the invention is easily scalable for any number of master devices, as previously stated, and a system designer no longer needs to focus on address space restriction due to additional master devices in the system. Advantageously, interconnect address decoding is simplified using techniques in accordance with embodiments of the invention; in the exemplary system 200 depicted in FIG. 2, the bus interconnect 210 only needs to decode one address space rather three address spaces, as required for the system 100 shown in FIG. 1. By simplifying the bus interconnect design in the system 200, a reduction in integrated circuit area is achieved. Moreover, by reducing the number of remapping logic blocks required compared to other interconnect approaches, a corresponding reduction in overall power consumption is realized.

Although the illustrative system 200 shown in FIG. 2 includes a single bus interconnect 210 largely for ease of explanation, it is to be appreciated that multiple bus interconnects may be employed, each bus interconnect being in operative communication with a corresponding common memory or two or more bus interconnects being in operative communication with the same common memory. A remapping scheme consistent with embodiments of the invention described herein can be utilized by all or a subset of the bus interconnects in the system.

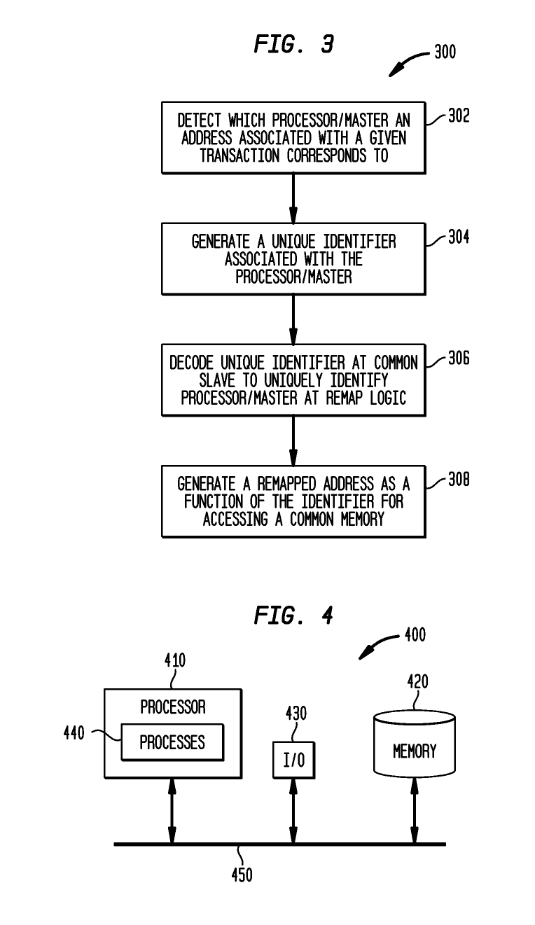

FIG. 3 is a flow diagram depicting at least a portion of an exemplary method 300 for remapping addresses in a multiprocessor system, according to an embodiment of the invention. With reference to FIG. 3, the method 300, in step 302, is operative to detect which of a plurality of processors (e.g., master devices) in the system an address associated with a given bus transaction corresponds to. In step 304, a unique identifier (e.g., identification routing bits) is generated (e.g., by the bus interconnect 210 in FIG. 2) and associated with the processor detected in step 302. The unique identifier may be generated in step 304 by the bus interconnect (210) appending routing bits, corresponding to a transaction between a given master device (e.g., Master0, Master1, or Master2) and a common slave device (e.g., common memory 208) through the bus interconnect, to actual ID bits associated with the given master device, as stated above.

The unique identifier is decoded in step 306 to identify which one of the master devices is requesting access to the common slave device for a given bus transaction. The decoding may be performed, for example, by parsing the unique identifier into its component routing bits and actual ID bits to thereby isolate the routing bits. Such parsing can be performed using one of various known parsing techniques, as will be apparent to those skilled in the art. A remapped address is then generated in step 308 as a function of the unique identifier for accessing common memory in the system (e.g., common memory 208 in FIG. 2). As previously stated, this approach beneficially eliminates the need for using separate remapping logic for each processor/master in the system.

Embodiments of the invention can employ hardware, software, or hardware and software aspects. Software includes but is not limited to firmware, resident software, microcode, etc. One or more embodiments of the invention or portions thereof may be implemented in the form of an article of manufacture including a machine readable medium that contains one or more programs which when executed implement method step(s) used to perform at least portions of embodiments of the invention; that is to say, a computer program product including a tangible computer readable recordable storage medium (or multiple such media) with computer usable program code stored thereon in a non-transitory manner for performing one or more of the method steps indicated. Furthermore, one or more embodiments of the invention or elements thereof can be implemented in the form of an apparatus including a memory and at least one processor (e.g., master device) coupled with the memory and operative to perform, or facilitate the performance of, exemplary method steps.

As used herein, “facilitating” an action includes performing the action, making the action easier, helping to carry out the action, or causing the action to be performed. Thus, by way of example only and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a tangible computer-readable recordable storage medium (or multiple such media). Appropriate interconnections via bus, network, and the like can also be included.

Embodiments of the invention may be particularly well-suited for use in an electronic device or alternative system (e.g., multiprocessor systems, multilayer and multilevel interconnect systems, memory storage systems, etc.). For example, FIG. 4 is a block diagram depicting at least a portion of an exemplary processing system 400 according to an embodiment of the invention. System 400, which may represent, for example, a multiprocessor system-on-chip (SoC) interconnect, or a portion thereof, includes a processor 410 (e.g., Master0, Master1 or Master2 shown in FIG. 2), memory 420 (e.g., common memory 208 shown in FIG. 2) coupled with the processor (e.g., via a bus 450 or alternative connection means) or embedded in the processor, as well as input/output (I/O) circuitry 430 operative to interface with the processor. The processor 410 may be configured to perform at least a portion of the functions according to embodiments of the invention (e.g., by way of one or more processes 440 which may be stored in memory 420 and loaded into processor 410), illustrative embodiments of which are shown in the previous figures and described herein above.

It is to be appreciated that the term “processor” as used herein is intended to include any processing device, such as, for example, one that includes a CPU and/or other processing circuitry (e.g., network processor, microprocessor, digital signal processor, etc.). Additionally, it is to be understood that a processor may refer to more than one processing device, and that various elements associated with a processing device may be shared by other processing devices. The term “memory” as used herein is intended to include memory and other computer-readable media associated with a processor or CPU, such as, for example, RAM, read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., display, etc.) for presenting results associated with the processor.

Accordingly, an application program, or software components thereof, including instructions or code for performing methodologies according to embodiments of the invention, as described herein, may be stored in a non-transitory manner in one or more of the associated storage media (e.g., ROM, fixed or removable storage) and, when ready to be utilized, loaded in whole or in part (e.g., into RAM) and executed by the processor. In any case, it is to be appreciated that at least a portion of the components shown in the previous figures may be implemented in various forms of hardware, software, or combinations thereof (e.g., one or more microprocessors with associated memory, application-specific integrated circuit(s) (ASICs), functional circuitry, one or more operatively programmed general purpose digital computers with associated memory, etc). Given the teachings of the embodiments of the invention provided herein, one of ordinary skill in the art will be able to contemplate other implementations of the embodiments of the invention.

At least a portion of the embodiments of the invention may be implemented in an integrated circuit. In forming integrated circuits, identical die are typically fabricated in a repeated pattern on a surface of a semiconductor wafer. Each die includes a device described herein, and may include other structures and/or circuits. The individual die are cut or diced from the wafer, then packaged as an integrated circuit. One skilled in the art would know how to dice wafers and package die to produce integrated circuits. Integrated circuits so manufactured are considered part of this invention.

An integrated circuit in accordance with embodiments of the invention can be employed in essentially any application and/or electronic system in which multiple processors or a bus interconnect may be employed. Suitable systems for implementing techniques of embodiments of the invention may include, but are not limited to, servers, personal computers, data storage networks, etc. Systems incorporating such integrated circuits are considered part of embodiments of the invention. Given the teachings of embodiments of the invention provided herein, one of ordinary skill in the art will be able to contemplate other implementations and applications of the techniques of embodiments of the invention.

The illustrations of embodiments of the invention described herein are intended to provide a general understanding of the structure of various embodiments, and they are not intended to serve as a complete description of all the elements and features of apparatus and systems that might make use of the structures described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the inventive subject matter are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A method for mapping addresses between one or more master devices and at least one common slave device in a multiprocessor system, the system including a bus interconnect for interfacing between the one or more master devices and the at least one common slave device, the method comprising steps of:
receiving a first address corresponding to a bus transaction between a given one of the one or more master devices and the common slave device;
decoding a unique identifier associated with the given one of the one or more master devices; and
generating a second address as a function of the first address and the unique identifier for remapping access to the common slave device by the given one of the one or more master devices.

2. The method of claim 1, wherein at least one of the one or more master devices comprises a processor.

3. The method of claim 1, wherein the at least one common slave device comprises a memory.

4. The method of claim 1, wherein the unique identifier comprises routing bits identifying the given one of the one or more master devices corresponding to the bus transaction between the given one of the one or more master devices and the common slave device.

5. The method of claim 1, further comprising the bus interconnect appending the unique identifier to identification bits associated with the given one of the one or more master devices to generate a new identifier, and providing the first address and new identifier to a remapping module for generating the second address.

6. The method of claim 5, wherein the step of decoding the unique identifier comprises parsing the new identifier to separate the unique identifier from the identification bits.

7. The method of claim 1, wherein the method is operative for eliminating a need for a separate remapping module corresponding to each of the one or more master devices.

8. The method of claim 1, further comprising generating rules assigning an action to each of at least a subset of possible values of the unique identifier.

9. The method of claim 8, wherein the step of decoding the unique identifier comprises initiating an action as a function of the rules and a value of the unique identifier.

10. The method of claim 1, further comprising generating the unique identifier, a number of bits in the unique identifier being a function of a master interface identifier bit width and a total number of master devices in operative communication with the bus interconnect.

11. An apparatus for facilitating address mapping between one or more master devices and at least one common slave device in a multiprocessor system, the apparatus comprising:
a bus interconnect in operative communication with the one or more master devices and the at least one common slave device, the bus interconnect being operative to receive a first address corresponding to a bus transaction between a given one of the one or more master devices and the common slave device and to decode a unique identifier associated with the given one of the one or more master devices; and
a remapping module in operative communication with an output of the bus interconnect, the remapping module being operative to generate a second address as a function of the first address and the unique identifier for remapping access to the common slave device by the given one of the one or more master devices.

12. The apparatus of claim 11, wherein at least one of the one or more master devices comprises a processor.

13. The apparatus of claim 11, wherein the at least one common slave device comprises a memory.

14. The apparatus of claim 11, wherein the unique identifier comprises routing bits identifying the given one of the one or more master devices corresponding to the bus transaction between the given one of the one or more master devices and the common slave device.

15. The apparatus of claim 11, wherein the bus interconnect is configured to append the unique identifier to identification bits associated with the given one of the one or more master devices to generate a new identifier, and to provide the first address and the new identifier to the remapping module for generating the second address.

16. The apparatus of claim 11, wherein the bus interconnect comprises a master interface for each of at least a subset of master devices in operative communication with the bus interconnect.

17. The apparatus of claim 16, wherein a number of bits in the unique identifier is a function of a master interface identifier bit width and a total number of master devices in operative communication with the bus interconnect.

18. The apparatus of claim 11, wherein the remapping module is operative to generate a set of rules assigning an action to each of at least a subset of possible values of the unique identifier.

19. The apparatus of claim 18, wherein the remapping module is further operative to initiate an action as a function of the rules and a value of the unique identifier.

20. The apparatus of claim 11, wherein the apparatus is configured so as to eliminate a need for the bus interconnect to have more than one remapping module in operative communication therewith.

21. The apparatus of claim 11, wherein at least a portion of the apparatus is fabricated in at least one integrated circuit.

22. The apparatus of claim 21, wherein the at least one common slave device comprises embedded memory in the at least one integrated circuit.

23. An electronic system, comprising:
a plurality of processors;
at least one common memory;
a bus interconnect coupled with the plurality of processors and the at least one common memory, the bus interconnect being operative to receive a first address corresponding to a bus transaction between a given one of the plurality of processors and the common memory and to decode a unique identifier associated with the given one of the plurality of processors; and
a remapping module coupled with an output of the bus interconnect, the remapping module being operative to generate a second address as a function of the first address and the unique identifier for remapping access to the common memory by the given one of the plurality of processors.

24. An apparatus for facilitating address mapping between one or more master devices and at least one common slave device in a multiprocessor system, the apparatus comprising:
at least one processor in operative communication with the one or more master devices and the at least one slave device, the at least one processor being operative: (i) to receive a first address corresponding to a bus transaction between a given one of the one or more master devices and the at least one slave device; (ii) to decode a unique identifier associated with the given one of the one or more master devices; and (iii) to generate a second address as a function of the first address and the unique identifier for remapping access to the at least one slave device by the given one of the one or more master devices.
